(19) United States
(12) Patent Application Publication
(10) Pub. No.: US 2014/0048613 A1
(43) Pub. Date: Feb. 20, 2014

(54) METHOD AND SYSTEM FOR ACCELERATING DISSIPATION OF A LANDFALLING TROPICAL CYCLONE

(71) Applicant: DHANANJAY MARDHEKAR, PUNE (IN)

(72) Inventor: DHANANJAY MARDHEKAR, PUNE (IN)

(21) Appl. No.: 13/958,634

(22) Filed: Aug. 5, 2013

(30) Foreign Application Priority Data
Aug. 9, 2012 (IN) 370/MUM/2012

(51) Int. Cl. A01G 15/00

(52) U.S. Cl. CPC A01G 15/00
USPC 239/2.1; 239/14.1

(57) ABSTRACT

Disclosed herein is a method and system for accelerated dissipation of a tropical cyclone and/or a hurricane specifically as it makes a landfall in order that its strength and access to further geography are significantly reduced in an irreversible manner. A storage tank and pipeline-based system for forcefully dispensing large amounts of cool dry air into the landfalling cyclone and/or hurricane system is the key embodiment proposed herein by which large scale dilution of the cyclone/hurricane fuel (vapor) is achieved. Other embodiments suggest augmenting this system with dry air drawn from adjoining arid or desert territories, and introduction of seeding materials or cloud condensation nuclei.

### CROSS-REFERENCE TO RELATED APPLICATIONS

This application is a Convention application claiming priority under 35 U.S.C. 119 from application No. IN370/MUM/2012 filed on 9 Aug. 2012 with the Patent Office, India.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention relates generally to technologies for countering cyclones and/or hurricanes with intention of reducing their destructive potential and more specifically to a method and system for accelerated dissipation of a cyclone and/or hurricane specifically as it approaches land in order that its strength and access to further geography are significantly reduced in an irreversible manner.

### BACKGROUND OF THE INVENTION

Numerous techniques have been suggested over the years to modify the tropical cyclones or hurricanes. Seeding clouds with dry ice or silver iodide, cooling the ocean with cryogenic material or icebergs, exploding the hurricane apart with hydrogen bombs, pumping the deep cool sea water up by pumps and spreading this cold water on the sea surface to reduce the evaporation are some of the examples. It has been suggested that the cyclonic vortex winds that help maintain the cyclone could be disrupted by explosive blasts, but there has been no confirmation of this thesis due to the difficulties in actually delivering an explosive to the appropriate location, especially without causing other problems and endangering lives or property. Though carefully reasoned, these suggestions have many shortcomings. However, after many experiments, the results were inconclusive. In spite of many efforts by scientists and for many decades, no momentous success in taming cyclones has been achieved.

Among patent art, following references deserve notable mention: U.S.20080035750 proposes providing another source of air for the center of the cyclonic wind from outside, preventing the upward flow of air in the center or the downward flow of air around the inside wall of the cyclonic wind and slowing the cyclonic wind directly. However, this technique necessitates involvement of an explosive device that is delivered by a mechanical drone and detonated to deliver the force necessary to reduce the cyclone's power. Such usage is undesired due to polluting nature of its application and also hazard due to improper delivery of the explosive payload.

U.S.20070114298 and U.S. 20070158452 propose methods for abatement of hurricanes by delivery of various coolants or super coolant in either their liquid, gaseous, or solid states and applying such coolants to energy feeding regions of the atmospheric disturbance. However, this technique cannot avoid addition of chemicals/residues to the environment and also of limited applicability decided by extent of delivery of the coolants into the cyclone system.

Another reference, U.S.20070257126, proposes lowering sea surface temperatures to reduce tropical cyclone intensity using a plurality of pumping distribution devices that pump cold sea water from a sea depth to a sea surface. U.S.20100264230 proposes a method of weakening a storm by delivery of liquid nitrogen or solid nitrogen pieces to a storm. U.S.20080023566 suggests suppressing the destructive force of a tropical cyclone by sea water pumped on-site from under the sea surface to above the surface, and then dispensed in the wind at the bottom of the cyclone in/near its eyewall. However, the practicality of such systems and deployment in sea currents of varying temperatures is very limited.

It is by and now evident that the state of art technologies have not been able to comprise an effective solution to aforementioned problems, thus preserving the need to invent for the present inventor who, after dedicated research, has proposed an effective solution to the same. The following description presents one way of performing the present invention.

### OBJECTS OF THE PRESENT INVENTION

The principle object of the present invention is to enable a modification maneuver for dissipation of a landfalling cyclone system to reduce its intensity and inward advance on land thus limiting its damage potential.

Another object of the present invention is to provide for dissipation of a landfalling cyclone system characterized in effectively reaching the intended result than was available previously.

Yet another object of the present invention is to provide a system for dissipation of a landfalling cyclone characterized in irreversible effect.

Yet another object of the present invention is to provide a system for dissipation of a landfalling tropical cyclone characterized in being preferably non additive to nature and does not result in addition of foreign materials to the environment.

Yet another object of the present invention is to provide a system for dissipation of a landfalling cyclone characterized in having costs-effective selection of materials, assemblage and operations.

These objects, together with other objects and advantages which will become subsequently apparent, reside in the details of preparation and application as more fully hereinafter described and claimed, reference being had to the accompanying drawings and detailed description set forth hereinafter

### BRIEF DESCRIPTION OF THE DRAWINGS

FIG. 1 illustrates the vertical section of a tropical cyclone and various anatomical parts of a tropical cyclone.

FIG. 2 illustrates the arrangement of the primary depots, auxiliary depots, and the linking means along the southern US coastal length.

FIG. 3 illustrates horizontal cross section of a landfalling tropical cyclone and the release of cold dry air into the eye-wall and a spiral rain band.

FIG. 4 illustrates the dry air from adjoining desert areas being actively carried through pipelines towards pipeline-based dry air dispensing system installed along the southern US coastal length.

FIG. 5 illustrates the dry air from adjoining desert areas being actively carried through pipelines towards pipeline-based dry air dispensing system installed along the southern US coastal length along with the cold dry air dispensing system.

A better understanding of the objects, advantages, features, properties and relationships of the present invention will be obtained from the following detailed description which set forth an illustrative preferred embodiment and which is indicative of the various ways in which the principles of the invention may be employed.

### SUMMARY OF THE PRESENT INVENTION

The present inventor proposes herein a novel approach for accelerated dissipation of a landfalling cyclone and/or hurricane characterized in the manifestation of large-scale and sudden dilution of the vapor concentration in the vapor-rich air entering into the cyclone and/or hurricane system thereby stripping the latent heat content released from condensation from water vapor resulting in weakening of the cyclone and/or hurricane system. Site of such intervention is deliberately selected in the landfalling zone wherein supply of vapor from landed territory is virtually non-existent thereby preventing the cyclone and/or hurricane system from regaining strength and thus making the weakening effect irreversible. In alternative embodiments of the present invention, the air to be injected is drawn from depots and conveyed along specially designed conduits optionally augmented with supply of air drawn from adjoining arid or desert areas and in another embodiment, with seeding materials.

Construction, positioning, actuation and operation of this system are few novel areas described in the detailed description to follow.

### DETAILED DESCRIPTION OF THE PRESENT INVENTION

The present invention is directed to a method and system for accelerated dissipation of a cyclone and/or hurricane specifically as it approaches land in order that its strength and access to further geography are significantly reduced in an irreversible manner. Principally, general purpose of the present invention is to assess disabilities and shortcomings inherent to known systems comprising state of the art and develop new technology by incorporating all available advantages of prior art and none of its disadvantages.

For purposes of this specification, the term ‘landfall’ shall mean and refer to zone near coastal region along path of a cyclone and/or hurricane system and shall include substantially the inshore and offshore regions in addition to the coastline itself. Tropical Cyclone ‘TC’ is the generic term used hereinafter for tropical storm, and tropical hurricane. Typhoons and cyclones are synonyms of hurricanes. Henceforth in this patent application the term ‘tropical cyclone’ or the term ‘TC’ will include tropical storm, tropical cyclone, tropical hurricane, typhoon and cyclones.

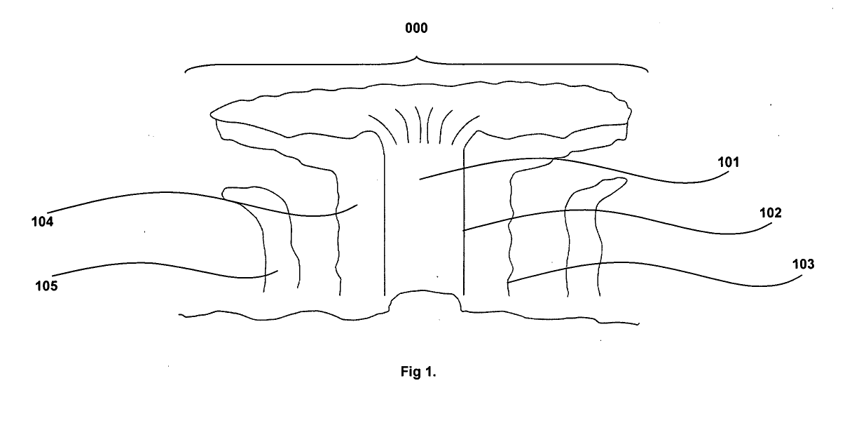

Reference is hereby made to FIG. 1 and the following description which briefly illustrates anatomical features of a tropical cyclone.

Eye: The eye 101 of a TC 000 is roughly a circular area of light winds and fair weather formed at the centre. There is little or no precipitation.

Eye-wall: Immediately outside the eye is the eye-wall region consisting of an inner eye-wall 102 and an outer eye-wall 103. Eye-wall 104 is the region of vigorous tall/deep clouds, strong updrafts, heavy rainfall, and the strongest winds.

Spiral rain bands: Spiral rain bands 105 are the bands of thunderstorms circulating outward from the eye-wall 104 that are part of evaporation/condensation cycle that feeds the tropical cyclones heat engine.

The inventor draws parallels from real life to base his methodology for accelerated dissipation of landfalling cyclones. Notable examples are:
a) Hurricane Lili was a category 4 hurricane over the Gulf of Mexico beginning early on Oct. 3, 2002. She rapidly weakened from a category 4 to a category 1 storm with her maximum sustained winds decreasing by 51.8 mph in the 13-hour period until she made landfall in Louisiana. It was found that this unexpected rapid weakening was caused by a natural input of low level drier air which moved into Lili from her west side explaining partially why Lili weakened rapidly.
b) Hurricane Gustav—It formed on the morning of Aug. 25, 2008, about 260 miles (420 km) southeast of Port-au-Prince, Haiti, and rapidly strengthened into a tropical storm that afternoon and into a hurricane early on August 26. Later that day it made landfall near the Haitian town of Jacmel. It inundated Jamaica and ravaged Western Cuba and then steadily moved across the Gulf of Mexico. Once into the Gulf, Gustav gradually weakened because of increased wind shear and dry air. It weakened to a Category 2 hurricane late on August 31, and remained at that intensity until landfall on the morning of September 1 near Cocodrie, La. Advection of dry air at on the western side of Opal aided in weakening the storm by helping to reduce the latent heat release in the inner core of the storm, leading to the collapse of the inner eye wall.

In these presents, before explaining at least one embodiment of the invention in detail, it is to be understood that the invention is not limited in its application to the details of participating components and to the description set forth hereinafter. The present invention is capable of other embodiments and of being practiced in various ways. Also, it is to be understood that the phraseology and terminology employed herein are for the purpose of description and should not be regarded as limiting.

From teachings of classical theory, it is known that the primary energy source of a tropical cyclone is the release of the latent heat from water vapor condensing in the cyclonic system. Solar heating of oceanic water is the initial source for evaporation and formation of water vapor. It is an intention therefore of the present invention to weaken the convective masses that drive the cyclone's engine thereby weakening it when it is most vulnerable—when it is landfalling and its source of vapor on land is practically cut.

What is needed primarily for purposes of the present invention is therefore an understanding of how a TC charts course and what intensity it harbors to accurately predict the path and hence plan site(s) and extent of intervening the landfalling TC.

From state of art studies, it is evident that forces affecting the steering of tropical cyclone systems are the higher latitude westerly wind, the subtropical ridge, and the beta effect caused by changes of the Coriolis force within fluids. Accurate track predictions depend on determining the position and strength of high and low pressure areas, and predicting how those areas will migrate during the life of a tropical system. The large scale synoptic scale flow also determines tropical cyclone's motion. The deep-layered mean flow through the troposphere determines the track direction and speed. If significant vertical wind shear is present in a storm, then for predicting the cyclone track the lower level wind speed is helpful. Determination of the intensity of a tropical cyclone is based on visible and infrared satellite image studies. There are several visual patterns that a cyclone may take on which the upper and lower bounds on its intensity can be defined. The patterns that are commonly used are curved band pattern, shear pattern, central dense overcast pattern, central cold cover pattern, banding eye pattern, and eye pattern.

The present inventor incorporates these technologies to his advantage in plotting sites of intervening a landfalling TC and further to plan the amount and duration of said intervention. Use of computer simulations using state of art simulation software in this perspective is intended to be covered by the present invention. Combining forecast models and data from Earth-orbiting satellites and other sensors with the determination of the forces that act on tropical cyclones; track forecasts of tropical cyclone is achieved. Besides, such computer studies can be based on the software like computational fluid dynamics software, wherein available data about the landfalling cyclone, like cyclone tracks, intensities, wind speeds, vapor content, sea surface temperature etc. can be incorporated. Similarly, data related to the terrain where the TC is expected to make a landfall, available data related to that TC from Earth-orbiting satellites, and other land based TC-monitoring systems etc can also be utilized.

To attain purpose of the present invention, attention is hereby drawn to accompanying figures which illustrate various embodiments of the present invention. In the following description and accompanying drawings, numerals and symbols are used for purpose of illustration and accordingly relate the details contained.

The present invention is characterized in including a novel, unique, cost-effective storage tank and pipeline-based system capable of injecting massive amounts of cool dry air into a landfalling TC. Operation of said system causes large-scale dilution of the vapor contained in the vapor-rich air of the landfalling TC thereby weakening it irreversibly and thus reducing further destruction imminent from inward progress of the TC.

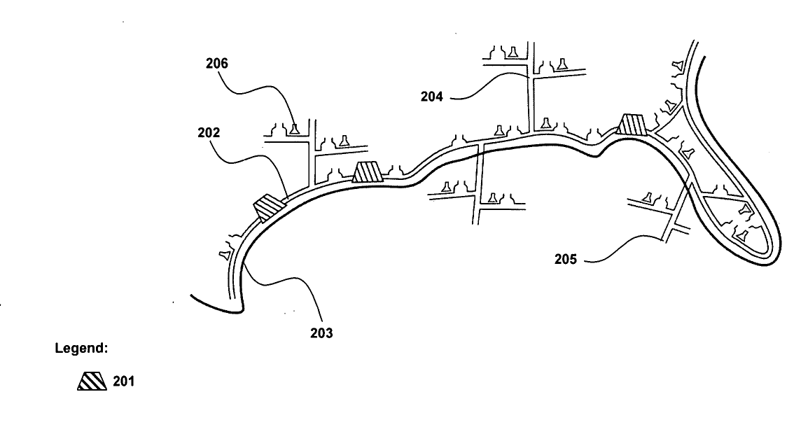

According to constructional aspects of the present invention and specific reference to FIG. 2, it can be seen that to achieve the above mentioned effect, multiple storage tanks (‘primary depots’) represented by 201 are installed along the TC-prone coast lines where a TC is expected to make landfall. The primary depots 201 are designed to hold liquefied air, for example, in the range of up to 200,000 tons each for release in the gaseous state into the approaching TC. Said depots 201, in alternative embodiments of the present invention, may comprise a single tank or multiple tanks of smaller capacity together building up total capacity intended for the depot 201. Said primary depots 201 would generally have double containers, wherein the inner container contains liquefied air and the outer container contains insulation materials. Modern liquid air storage tanks of full containment type having a pre-stressed concrete outer wall and a high-nickel steel inner tank and efficient insulation between the walls may be deployed. Generally, the primary depots are cylindrical in shape, perpendicular to the ground with flat bottoms and have a fixed or floating roof. Large tanks tend to be vertical cylindrical or have rounded corners from vertical side wall to bottom profile and designed to withstand hydraulic/hydrostatically-induced pressure of the contained liquid air.

According to a further aspect of the present invention, liquefied air is to be kept in its liquid state at very low temperatures. One of the ways to maintain the temperature within the tank to remain constant if the pressure is kept constant is by auto-refrigeration, that is, allowing the boil off liquefied air to escape from the tank. Upon requirement, cool dry air is released from said primary depots after being heated and converted to ordinary natural gaseous air. Release of liquefied air can be augmented and accelerated by suitable evaporators, vaporizers or heaters. (Generally, vaporizers utilize a large burner to minimize emissions. One of such available Vaporizer is Linde Engineering's combustion vaporizer).

According to another aspect of the present invention, the said primary depots 201 and pipelines 202 can be installed underground or partially underground or on the ground depending on considerations of costs, engineering feasibility and geographical aesthetics. There are usually many environmental regulations applied to the design and operation of storage tanks, often depending on the nature of the fluid contained within them. Aboveground storage tanks differ from underground storage tanks in the kinds of regulations that are applied. Most storage tanks are designed to handle varying degrees of pressure. For example, such storage tanks are used for storing liquefied natural gas, wherein the tank type is the full containment tank. Here, the storage tanks are roughly 55 m (180 ft) high and 75 m (250 ft) in diameter (=250 000 m³). Other examples of such large storage tanks are the 180 million liters full containment type for Osaka Gas Co. Ltd. or 200 million liters Membrane type for Toho Gas Co. Ltd. Infrastructural costs may be reduced by installing multiple primary depots of smaller capacity to together hold requisite amount of liquefied air required for performance of the present invention.

According to another aspect of the present invention, the pipeline routes along the coastal areas are planned using topographic maps followed by actual ground surveying. Pipelines can be constructed working from one end to another or simultaneously in sections which are then connected. A pipeline is preferably cleaned, primed and coated with a tar-like material to prevent corrosion and wrapped in an outer layer of heavy paper, mineral wool or plastic. If the pipe of a pipeline is to be buried, the bottom of the trench is prepared with a sand or gravel bed. The pipe may be weighed down by short, concrete sleeves to prevent its lifting out of the trench from groundwater pressure. After the underground pipeline is placed in the trench, the trench is backfilled and the surface of the ground returned to normal appearance. After coating and wrapping, aboveground piping is lifted up onto prepared stanchions or casements, which may have various design features such as anti-earthquake shock absorption. Pipeline 202 may be insulated or have heat trace capabilities to keep products at desired temperatures throughout transport.

Vaporizers included above have to be utilized for quickly converting the compressed and liquefied air in the primary depot 201 into the gaseous state. Here, prior to the utilization of vaporizers, the liquefied air stored in the primary depots 201 is agitated so that the natural composition of the air is maintained when the evaporated air is released into the TC. Instead of primary depots 201 containing liquefied air, in yet another embodiment, primary depots 201 containing compressed air may also be used for easier handling of the contained air.

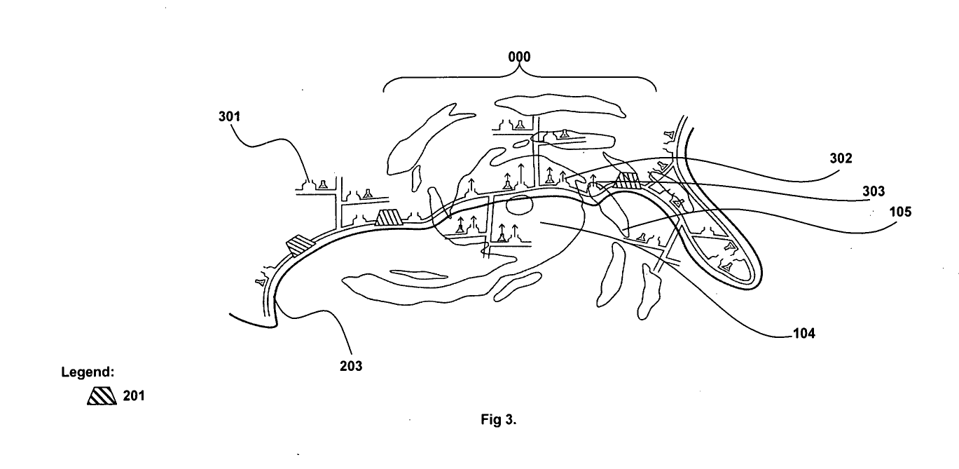

Referring to FIG. 3, it can be seen that liquefied air from the primary depots 201 is released in a controlled manner via suitable outlet(s) represented by 301 wherein each of said outlet(s) 301 includes a valve for controlling release of the vaporized air. Common art spring-loaded valve plugs, cocking arms, dump valves, their variants and their combinations may be used to control the flow, pressure and temperature of the released vaporized air in response to the actuation signalling done automatically or manually by electrical, hydraulic or pneumatic means.

Referring to FIGS. 2 and 3, it may be seen that multiple depots 201 are installed along the coast line 203 where the TC is expected to make landfall. Interconnecting pipelines 202 are arranged to transport air discharged from said depots 201. Air pumps or high capacity propellers are installed in said pipelines 202 to maintain high pressures needed for delivery into the TC via release means represented by 301 installed on depots 201 (not shown in figure) and pipelines 202. To increase the points of introduction of the said cool air into a cyclone, several branches 204 are incorporated in the said pipelines 202, wherein, attached to each said branch, a plurality of ‘cool air release means’ 301 (CARM) are included. The said pipelines and their branches are mainly installed onshore along the hurricane prone coast line 203. However, some branches 205 possibly extend offshore or even up to the nearby islands. A network of pipelines is thus designed for effective multiple point introduction.

The CARMs 301, are a plurality of devices that are connected with the said pipelines 202 for release of massive amounts of cool air rapidly into the desired locations in a TC. For the effective and efficient injection of massive amounts of cool dry air in a landfalling TC, such CARM devices 301 are preferably regularly spaced at an interval of 500 meters on the said network of pipelines 202. However, the frequency of said CARM devices may vary as per the geographical layout of the land.

The said CARMs 301 can also be installed on the said pipelines 202 or juxtaposed alongside the said pipelines 202. The CARM device 301 may consists of an air driving pump or a high capacity propeller driven by electric motors or diesel engines so as to forcefully inject air in massive amounts into the TC. The CARM 301 has a discharge valve which controls the air discharge at a desired flow rate and allows continuous automatic control of air discharge. In alternative embodiments, preferably at each location of a CARM 301, an auxiliary depot with means for dispending seeding material (SMRM) represented by 206 is also installed for the simultaneous release of seeding materials like silver iodide, dry ice, salt, urea, ammonium nitrate, compressed liquid propane, compressed carbon dioxide etc along with the cool dry evaporated air. SMRM 206 can also contain cloud condensation nuclei such as microscopic dust, smoke, aerosols etc. for simultaneous release along with cool dry evaporated air. A combination of the above mentioned materials may also be used for the release.

FIG. 3 depicts such hurricane prone coast line 203 in USA depicting US coast and Gulf of Mexico. Liquefied air from depots 201 is evaporated and then transported in gaseous state through pipelines 202. The said pipelines 202 may be varying in size from several centimeters to a meter or more in diameter. Evaporated cool air is thus moved to long distances through network of pipelines 202 and driven by large pumps located along the route of the pipeline 202 at specific locations or intervals. (Distance between the two consecutive pumps is determined by the pump capacity, viscosity of the product, size of the pipeline and the type of terrain crossed etc). Pipeline pumping pressures and flow rates are controlled throughout the system to maintain a constant movement of cool air within the pipeline 202.

In the embodiment where depot 201 comprises multiple smaller tanks, the smaller tanks are connected via pressure guide rings which receive air under pressure from one or more connected tanks and direct the air through an output pipeline towards the CARM 301. Flow of air under pressure is controlled by a power regulator and controller which monitors the power output from the generator and transmits electrical signals to adjust the open and closed positioning of a tank output valve on each of the plurality of tanks. Generally, pipeline operations include pipeline control, pumping and controlling the evaporated air outflow through delivery terminals. The size and length of the pipeline, pipeline pumping stations, pressures and flow rates are to be completely controlled in order to ensure appropriate flow rates and continuous operations. Generally, an operator achieves a computerized control for the pumps, valves, regulators and compressors throughout the pipeline system from a central location. A large liquefaction plant (not shown in the drawing) may be conveniently installed near the coastline where the primary depots are installed for charging said primary depots 201 with liquefied air.

Monitoring and tracking systems mentioned hereinabove allows understanding of location of various regions of an approaching TC like the eye 101, eye-wall 104, inner eye-wall 102, outer eye-wall 103, spiral rain bands 105 and updrafts (not shown in the drawing). When these regions of a TC come over the CARMs 301, then by appropriate actuation, massive amounts of cold dry air is introduced rapidly into the said various prejudged regions of the landfalling TC. Here, the liquefied air stored in the depots 201 is agitated, prior to the vaporization and release, to maintain the natural composition of the air. The conversion of the liquefied air to the gaseous air is augmented and accelerated by evaporators or vaporizers or suitable heaters and driven by the propellers and other means described hereinabove.

FIG. 3 depicts southern US coastline 203 and a horizontal cross section of a landfalling TC 000, a spiral rain band 105 and the eye-wall 104. Cold dry air is introduced at site represented by 302 into the eye-wall 104 and at site 303 into the spiral rain band 105 of the landfalling TC 000. As a part of the landfalling TC 000 is on the land, the simultaneous introduction of cold dry air in huge quantities directly into the above defined parts of the TC severely interferes with the TC resulting in its faster dissipation.

It is known that TCs are vital sources of rain. Therefore, the inventor also proposes modifying the landfalling TC so that fresh water in the form of rains can be received on land while limiting the destruction. Referring back to FIG. 3, it can be seen that for yet another embodiment, along with each of the plurality of CARMs 301, SMRMs 206 are also installed for the simultaneous release of the seeding materials and/or cloud condensation nuclei along with the large quantities of cool dry air. Here, dispersion of tonnes of seeding materials or cloud condensation nuclei by cargo planes could also be added for further enhancement of the dissipation of the TC (not shown in the drawings). In yet another embodiment, such sprinkling of seeding materials or cloud condensation nuclei in to the swirling TC along with the introduction of massive amounts of cool dry air as described in the preferred embodiment for carrying out the dilution of the vapor contained in the vapor-rich air of the landfalling TC would have a synergistic effect. The dual intervention of the cyclone would surely starve the cyclone of its energy. For the purpose of sprinkling of seeding materials or cloud condensation nuclei in to the swirling cyclone along with the introduction of massive amounts of cool dry air as described in the preferred embodiment, auxiliary depots are juxtaposed in the vicinity of the release means and made to suitable dimensions capable of holding seeding materials intended to be optionally dissipated along with output of the contents of the primary depots.

The reader would now be aware that the present invention draws its applicability from the selection of site, time and mode for intervention, which in fact, bring together the situation that a TC is landfalling and naturally deprived of its vapour fuel to a substantial extent for forceful injection of cool dry air from CARMs and seeding materials/cloud condensation nuclei from the SMRMs and/or cargo planes which makes possible the synergy required for accelerated dissipation of the landfalling TC.

The region near the sea surface is vapor rich. This vapor provides latent heat to the TC's engine. As the cold dry air is artificially introduced in massive amounts as described hereinbefore, the vapor in the lower zone of approaching TC will get condensed. The introduction of cloud seeding material and/or cloud condensation nuclei via the SMRM devices (auxiliary depots) placed at the ground level will enhance the precipitation of this condensed vapor. The blown seeding material would mix up with the air flows of the TC enhancing the precipitation by providing nuclei. This precipitation will starve the TC by depriving it of its vapor fuel. One of the methods employed in the SMRM would be blowing the seeding material, stored in SMRM devices, by powerful blowers in to the desired locations of approaching cyclonic system. Another mechanism that could be employed in SMRM devices would be blowing fumes of silver iodide upwards by blowers. The seeding material would rise into the clouds due to flows of the TC winds and interact with the clouds with resultant good precipitation.

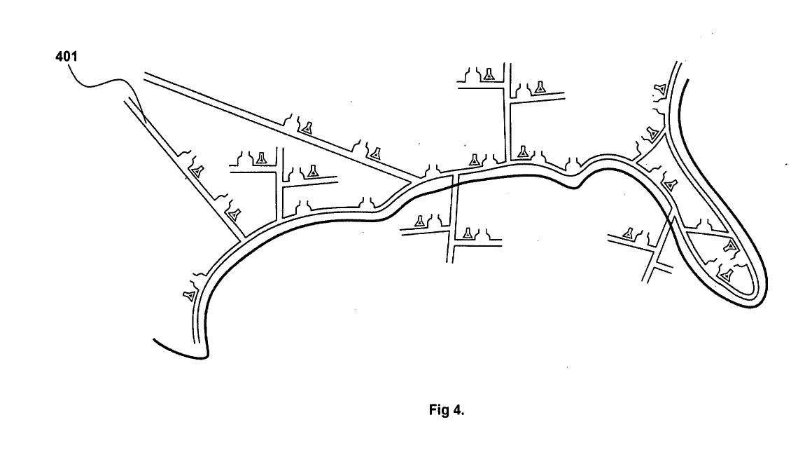

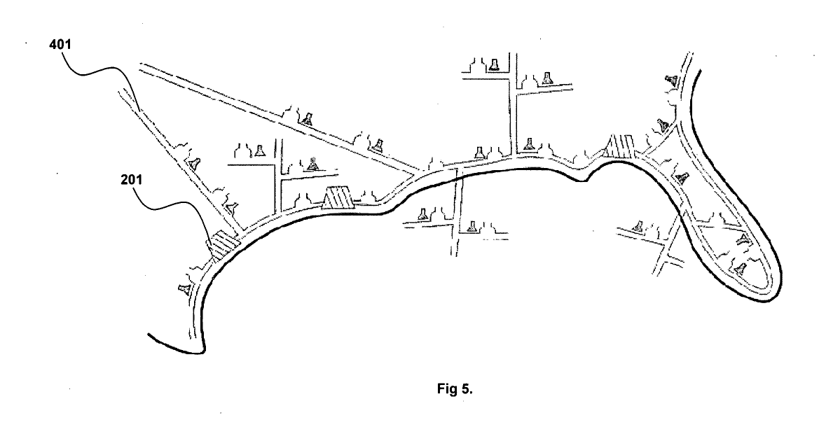

In yet another embodiment of the present invention as depicted in FIG. 4, pipelines 401 are laid to bring dry air from the adjoining arid or desert areas like Chihuahuan Desert, Texas, United States. A large quantity of such dry air is pumped through said pipelines 401 to introduce it into the pipelines 202 towards the CARMs 301. Said dry air may itself be used as a heat source for evaporating the liquefied air contained in primary depots 201. A massive amount of dry air from the desert places is therefore rapidly introduced in a landfalling TC in order to accelerate the dissipation of that TC. FIG. 5 depicts the dry air from adjoining desert being actively carried through pipelines 401 towards the pipeline-based cool dry air dispensing system comprising depots 201. This embodiment is intended at application of the present invention wherein primary depots 201 are not needed, and air from pipelines 401 and 202 are used instead.

As will be realized, the present invention is capable of various other embodiments and that its several components and related details are capable of various alterations, all without departing from the basic concept of the present invention. Therefore, the invention should not be regarded as being limited in scope to the specific embodiments of method and system or operations disclosed herein, but instead as being fully commensurate in scope with the following claims.

I claim:

1. A system to accelerate dissipation of a landfalling tropical cyclone 000, said system comprising:
tracking means chosen among Earth orbiting satellites and determination of forces such as Coriolis force, higher latitude westerly wind, the subtropical ridge and use of tropical cyclone forecast software for determining the location and course of said tropical cyclone and plotting at least one site for intervention;
means chosen among visible and infrared satellite image studies for determining the strength of said tropical cyclone;
at least one primary depot 201 made to suitable dimensions capable of holding around 1000 to around 200000 tons of cold liquefied air, said depot 201 being situated in a geography irrespective of being known to be cyclone prone;
at least one auxiliary depot 206 with built-in release means juxtaposed in the vicinity of release means 301 and made to suitable dimensions capable of holding at least one among seeding materials and cloud condensation nuclei intended to be optionally dissipated along with output of the primary depot 201;
means 202 for linking primary depots 201 forming a network for conveying and dissemination of contents of the said primary depots 201 over a large geographical expanse;
means 401 for conveying dry air from adjoining drier territories for dissemination into the landfalling tropical cyclone;
release means 301 installed on the depots 201, linking means 202, 205 and 401 to release among contents of depots 201, dry air drawn from the adjoining drier territories and their combinations; and
remote actuation means chosen among manual and automatic types for actuating the primary and auxiliary depots at selected sites for intervention intended at accelerating dissipation of the landfalling tropical cyclone

2. The system to accelerate dissipation of a landfalling tropical cyclone according to claim 1, wherein said cold liquefied air is chosen among dry and moisture-bearing varieties.

3. The system to accelerate dissipation of a landfalling tropical cyclone according to claim 1 wherein said depots 201 are embedded below ground surface to preserve geographical aesthetics.

4. The system to accelerate dissipation of a landfalling tropical cyclone according to claim 1 wherein said depots 201 are partially embedded below ground surface.

5. The system to accelerate dissipation of a landfalling tropical cyclone according to claim 1 wherein the depots 201, linking means 202, 205 and 401 bear release means 301 at predetermined intervals for synchronized forceful and massive delivery of air into the cyclonic system

6. The system to accelerate dissipation of a landfalling tropical cyclone according to claim 1 wherein said seeding materials and cloud condensation nuclei are chosen among the group comprising silver iodide, dry ice, salt, urea, ammonium nitrate, compressed liquid propane, compressed carbon dioxide, microscopic dust, smokes, aerosols and their combinations.

7. The system to accelerate dissipation of a landfalling tropical cyclone according to claim 1, wherein said means 202 for conveying and dissemination of contents of the said primary depots 201 are continuous pipes chosen among branched and non-branched varieties characterized in bearing release means 301 at predetermined intervals of around 500 m.

8. The system to accelerate dissipation of a landfalling tropical cyclone according to claim 1, wherein said primary depots 201 are positioned along nodes of the conveying conduits 202 and proportioned to have either among equal and unequal volumes.

9. The system to accelerate dissipation of a landfalling tropical cyclone according to claim 1, wherein forceful output of air from the release means 301 is enabled via concerted action of acceleration means chosen among propellers and pumps installed at strategic locations along the pipelines 202 and release means 301.

10. A method for accelerated dissipation of a landfalling tropical cyclone using system of claim 1, said method comprising:
tracking means chosen among Earth orbiting satellites and determination of forces such as Coriolis force, higher latitude westerly wind, the subtropical ridge and use of tropical cyclone forecast software for determining the location and course of said tropical cyclone and plotting at least one site for intervention;
means chosen among visible and infrared satellite image studies for determining the strength of said tropical cyclone;
mapping geographical area along the coastline in the onshore region of a sea on the known course of propagation of a tropical cyclone where the tropical cyclone goes into a weakening state for demarcating probable region of intervening said tropical cyclone;
deploying at least one of the release means 301 and depots 206 for metered release of contents of said depots into the cyclonic system, said release being characterized in being modeled according to determination of course and strength of said cyclonic system, executed in areas chosen at least one among the eye 101, below the inner eye wall 102, below the outer eye wall 103, eye wall 104, spiral rain bands 105 and updrafts of said cyclonic system and such interference is sustained till said cyclone is subdued.

11. The method to accelerate dissipation of a landfalling tropical cyclone according to claim 10 wherein rate of release of contents from said primary depots 201 and auxiliary depots 206 is defined by the approach of a tropical cyclone, its strength, its expected course, its position over the zone of the said depots and the required sustaining cooling and expansion effect of cold air as deduced by computer simulations and computational fluid dynamics studies.

12. The method to accelerate dissipation of a landfalling tropical cyclone according to claim 10 wherein release from primary depots 201 and auxiliary depots 206 is fortified with dry air from adjoining desert and arid areas being actively directed by powerful motorized propellers introduced at strategic locations along conduits 401 leading from these areas to site of intervening the tropical cyclone.

13. The method to accelerate dissipation of a landfalling tropical cyclone according to claim 10 wherein depots 201 are absent and the dry air from adjoining desert and arid areas being actively directed by powerful motorized propellers introduced at strategic locations along conduits 401 and 202 and solely used for intervening the tropical cyclone by direct release from release means 301, and said release being optionally augmented with release from depots 206 and cargo planes.

14. The method to accelerate dissipation of a landfalling tropical cyclone according to claim 10 wherein release from primary depots 201 and auxiliary depots 206 is optionally augmented with release of seeding material and cloud condensation nuclei from cargo planes.

15. The method to accelerate dissipation of a landfalling tropical cyclone according to claim 10 wherein accelerated dissipation of a landfalling tropical cyclone is achieved by forcefully injecting cool dry air in massive amounts into a landfalling tropical cyclone thereby diluting its vapor fuel.

16. The method to accelerate dissipation of a landfalling tropical cyclone according to claim 10 wherein at time of dissipation of a landfalling tropical cyclone, cold liquefied air present in said depots is vaporized using vaporizers for quick conversion to a gaseous state.

17. The method to accelerate dissipation of a landfalling tropical cyclone according to claim 16 wherein, at the time of dissipation of a landfalling tropical cyclone, prior to the utilization of vaporizers, the cold liquefied air present in said depots 201 is agitated so that the natural composition of the air is maintained when evaporated air is released into said landfalling tropical cyclone.

18. The method to accelerate dissipation of a landfalling tropical cyclone according to claim 10 wherein the system of claim 1 is preferably installed along the hurricane prone coast lines.
